(19) United States
(12) Patent Application Publication
(10) Pub. No.: US 2008/0301654 A1
(43) Pub. Date: Dec. 4, 2008

(54) Program processing apparatus, program processing method and computer readable information recording medium

(75) Inventor: Osamu Hamaue, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/213,290

(22) Filed: Jun. 17, 2008

Related U.S. Application Data
(63) Continuation of application No. PCT/JP05/23654, filed on Dec. 22, 2005.

(51) Int. Cl. G06F 9/45

(52) U.S. Cl. 717/151

(57) ABSTRACT

A program processing apparatus comprising at least any one of an executable file compile possible part configured to carry out a predetermined executable file compile possible process to a program to make it possible to compile into an executable file the program, in such a state that the program has at least a part thereof enciphered, and a removal processing part configured to carry out a predetermined removing process to a program to remove an influence of the predetermined executable file compile possible process, which program has at least a part thereof enciphered and further has undergone the predetermined executable file compile possible process.

### CROSS-REFERENCE TO RELATED APPLICATION

This application is a U.S. continuation application filed under 35 USC 111(a) claiming benefit under 35 USC 120 and 365(c) of PCT application JP05/023654, filed Dec. 22, 2005. The foregoing application is hereby incorporated herein by reference.

### BACKGROUND OF THE INVENTION

1. Field of the Invention

The present invention relates to a program processing apparatus, a program processing method and a computer readable information recording medium, and in particular, to a program processing apparatus concerning a process carried out when a program product is provided, a program processing method carried out in the program processing apparatus, and a computer readable information recording medium storing a program for carrying out the program processing method.

2. Description of the Related Art

In order to provide a software program (simply referred to as a program hereinafter), there is a way of providing an executable file, and making it possible to install the executable file in an execution apparatus with the use of a special number (i.e., a key code) which is used to obtain permission for actually executing the file.

In such a manner, along with extension of functions of a program, a necessity arises to manage functions provided from the program for each user who receives the program product.

In such a case, for each user, a source program which is a collection of desired functional parts is created, is then compiled into an executable file, and is provided to the user. The executable file means a file of a so-called object program. For each user to whom the program is thus provided, management is carried out concerning updating of the program, and so forth.

Further, when a request is made from the user to whom the program is thus provided, to add a new function, a corresponding new source program is created, is then complied into an executable file, and is provided to the user in the same manner again.

Japanese Laid-Open Patent Application 2003-280754 discloses a related art.

In such a system of providing program products, it is necessary to separately manage, for each user, a program having a different functional specification. Thus, the management work may be complicated.

Further, an extra manpower may be required to respond to a user's additional request for a new function, to create a source program to add a corresponding functional part, and to compile it again.

For the purpose of solving the program, a single source program may be previously created including all possible functional parts. In this case, the functional parts other than a functional part which is actually desired by each particular user are enciphered, and then, the source program is provided to the user. However, in this method, the source program including the functional parts thus enciphered may cause an error when the source program is compiled into an executable file because it includes the enciphered functional parts.

### SUMMARY OF THE INVENTION

The present invention has been devised in consideration of the problems, and an object of the present invention is to provide a program providing system which makes it possible to unify management of programs provided to a plurality of users who require different functions from the programs. Further, by this program providing system, even when an additional request is made from a user to add a new function, it is not necessary to provide a corresponding new source program each time.

According to the present invention, a predetermined executable file compile possible process is carried out to a program to make it possible to compile into an executable file the program, in such a state that the program has at least a part thereof enciphered, or, a predetermined removing process is carried out to a program to remove an influence of the predetermined executable file compile possible process, which program has at least a part thereof enciphered and further has undergone the predetermined executable file compile possible process.

### BRIEF DESCRIPTION OF THE DRAWINGS

FIGS. 1 and 2 show a program processing system in one embodiment;

FIGS. 3 and 4 show a program processing system in another embodiment;

FIG. 5 shows a flow chart of an enciphering process in the program processing system in an embodiment;

FIG. 6 shows a flow chart of a deciphering process in the program processing system in an embodiment; and

FIG. 7 shows a block diagram of one example of a computer which can act as the program producing system in an embodiment.

### DESCRIPTION OF REFERENCE NUMERALS

10 SOURCE PROGRAM BEFORE BEING ENCIPHERED
11 SOURCE PROGRAM AFTER BEING DECIPHERED
20 SOURCE PROGRAM AFTER BEING ENCIPHERED
100 PROGRAM ENCIPHERING SYSTEM
200 PROGRAM DECIPHERING SYSTEM

### DESCRIPTION OF THE PREFERRED EMBODIMENTS

According to one embodiment of the present invention, a predetermined executable file compile possible process is carried out to a program to make it possible to compile into an executable file, in such a state that the program has at least a part thereof enciphered, or, a predetermined removing process is carried out to a program to remove an influence of the predetermined executable file compile possible process, which program has at least a part thereof enciphered and further has undergone the predetermined executable file compile possible process.

In this configuration, when a program product is provided, the predetermined executable file compile possible process to make it possible to compile into an executable file, in such a state that the program has at least a part thereof enciphered, is carried out previously to the program. As a result, a program providing party merely should create a single a source program including all possible functional parts previously. Then, when a program product is provided to each user, all the functional parts included in the single source program are enciphered except a specific functional part, which is actually desired by the user. After that, the above-mentioned executable file compile possible process is carried out on the source program, and then, the source program is provided to the user.

The source program thus provided to the user can be compiled into an executable file although the source program has the functional parts enciphered (referred to as second functional parts, hereinafter), except the specific functional part actually desired by the user, because the executable file compile possible process has been thus carried out on the source program before it is provided to the user.

As a result, the user can install the thus-obtained executable program or object program in an information processing apparatus such as a personal computer, and can actually execute the object program. As a result, the specific functional part which the user actually desires can be executed so that the user obtains a corresponding specific function therefrom.

It is noted that, the user cannot execute the second functional parts, which although have been originally included in the source program and are still included in the object program, because the second functional parts are enciphered as mentioned above before being provided to the user.

The user may make an additional request to use one of the second functional parts also included in the object program which has been provided to the user, but enciphered and thus, the user cannot actually use, as mentioned above. In response to the additional request, the program providing party provides the user with a corresponding deciphering key for deciphering the one of the second functional parts. With the use of the deciphering key, the user can decipher the one of the second functional parts, and as a result, the user can execute the one of the second functional parts to obtain a function therefrom.

Thus, according to the embodiment of the present invention, the program providing party should merely prepare a single source program including all possible functional parts. Then, for a plurality of users having requests for different functional parts included in the single source program, the source program is provided to each user after all the functional parts are enciphered except a corresponding specific functional part, and the executable file compile possible process is carried out. As a result, each user can execute only the corresponding specific functional part among the functional parts included in the provided program. In this meaning, each user has the program provided as if, the user has such a program provided separately, which includes only the corresponding specific functional part.

As a result, the program providing party should not separately manage a plurality of programs which were prepared for the plurality of users.

The program providing party should manage merely the single source program including all possible functional parts prepared in response to the respective requests of the plurality of users for respective different functional parts. Thus, it is possible to effectively reduce manpower of the program providing party required for preparing and managing programs to be provided to users.

In a program providing system in an embodiment, a user receives a source program which is enciphered in function unit. The user further receives a deciphering key concerning a necessary function, and therewith, the user can decipher the corresponding functional part of the source program. Thus, the user receives the source program in such a state that the required function can be used therefrom.

With the use of the program providing system, a program providing party should not manage a source program for each user. Instead, unified management of source programs is made possible, and thus, it is possible to simplify a program file preparing and managing work.

In a program enciphering system in an embodiment, a source program not yet enciphered is enciphered for function unit.

Further, in the program enciphering system, a predetermined executable file creation control code is embedded for function unit such that no error will occur when the program enciphered for function unit as mentioned above is compiled into an executable file.

In the program enciphering system, even when the enciphered source program thus provided to the user is obtained by a third person, the third person cannot decipher the enciphered source program unless the third person also obtains the deciphering key. Therefore, the third person cannot actually use the corresponding function therefrom.

Thus, according to the embodiments, instead of creating a program separately for each user and managing the same, the same program is provided to each user.

In this case, the same program provided to each user is a source program having all possible functions mounted therein. This source program is compiled into an executable file in a user environment, and thus, the user can actually use a corresponding function therefrom.

The above-mentioned program enciphering system is configured such as to restrict, for each user, an available executable function.

According to the program enciphering system, a program in which all possible functions are mounted is enciphered for each functional part by a different enciphering key.

Further, to each of the thus-obtained enciphered parts of the program, a predetermined control characters string (i.e., the above-mentioned predetermined executable file creation control code) is automatically embedded previously such that no error should occur when this source program including the enciphered parts will be compiled to an executable file in a user environment.

A user receives the source program thus enciphered in functional part unit. Also, especially for a necessary functional part, the user receives a deciphering key corresponding to the above-mentioned enciphering key, such that the necessary functional part can be deciphered. Thus, the user can obtain the source program including the necessary functional part in an executable state. By actually compiling the source program into an executable file, the user can actually use the corresponding function therefrom.

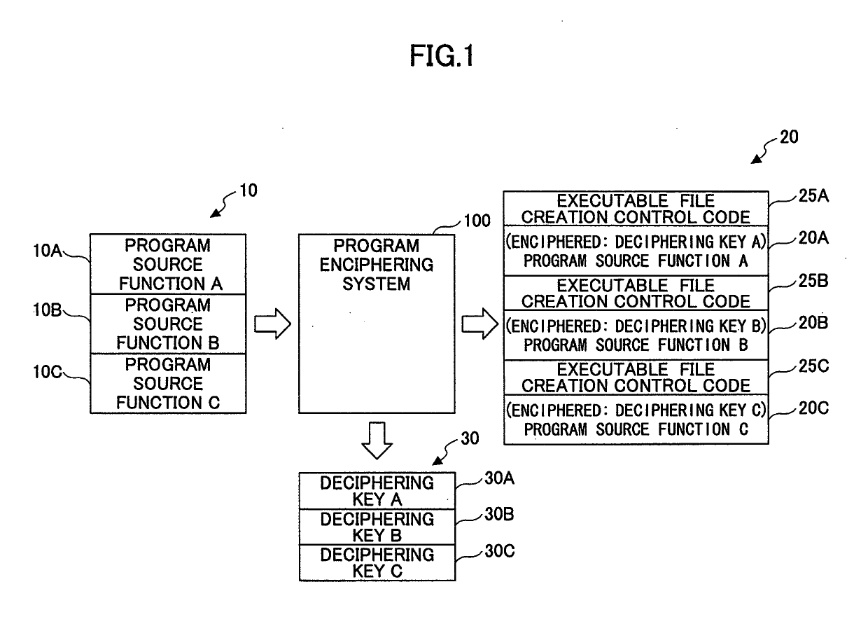

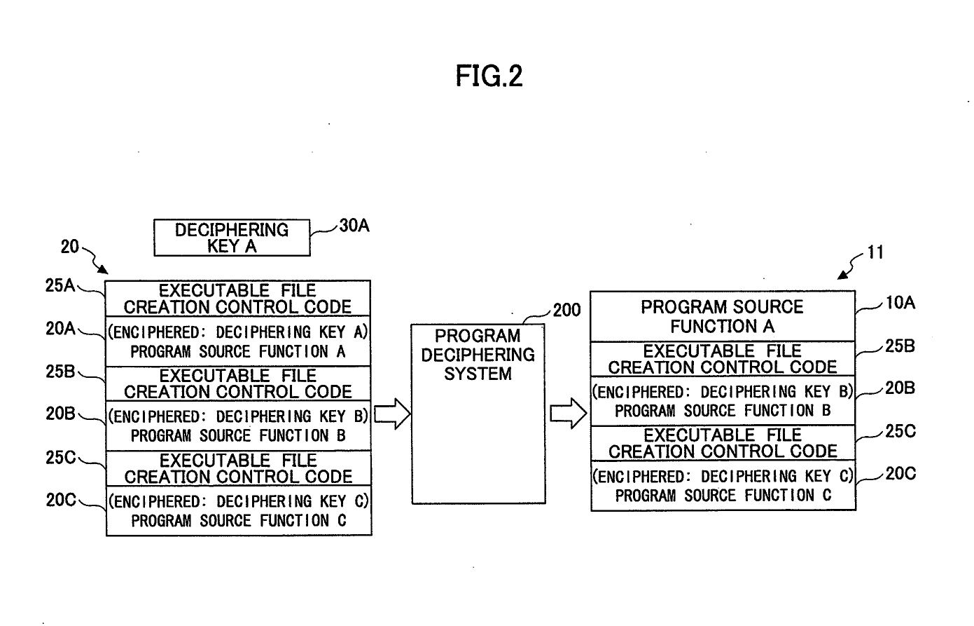

A program providing system in embodiment 1 will now be described with reference to FIGS. 1 and 2.

FIG. 1 illustrates a method of providing an enciphered source program.

In the example shown in FIG. 1, first, functional parts 10A, 10B and 10C, corresponding to functions A, B and C, respectively, are created in a source program 10. Then, a source program 10 is enciphered by means of a program enciphering system 100. Specifically, function units of the source program 10, i.e., the functional parts 10A, 10B and 10C, are enciphered separately. Further, deciphering information 30, including corresponding deciphering keys 30A, 30B and 30C, is generated.

The source program 10 including the three different functional parts 10A, 10B and 10C is input to a program enciphering system 100, the program enciphering system 100 generates and thus outputs a source program 20 to be provided to a user, which includes the above-mentioned three different deciphering keys 30A, 30B and 30C, as well as functional parts 20A, 20B and 20C, which are thus separately obtained from the original functional parts 10A, 10B and 10C as a result of the functional parts 10A, 10B and 10C being enciphered in three different enciphering manners, respectively.

Further, as shown in FIG. 1, in the enciphered source program 20, in addition to the enciphered functional parts 20A, 20B and 20C, executable file creation control codes 25A, 25B and 25C, provided separately for the respective functional parts 20A, 20B and 20C, are embedded. These executable file creation control codes 25A, 25B and 25C are control character strings embedded for the purpose of preventing an error from occurring when an executable file will be created from the source program 20. A process of providing the executable file creation control codes 25A, 25B and 25C to the source program 20, for example, is referred to as a predetermined executable file compile possible process.

Next, with reference to FIG. 2, a process which will be carried out by a user after the user receives the source program 20 which has been thus enciphered by means of the program enciphering system 100 shown in FIG. 1, such that the user can actually use the received source program 20, will be described.

First, the user requests deciphering key information corresponding to a necessary functional part, from a program providing party.

For example, it is assumed that the user requires the function A, corresponding to the functional part 20A. In this case, the user requests the program providing party for the corresponding deciphering key 30A.

After receiving the deciphering key 30A, the user inputs the deciphering key 30A, in addition to the above-mentioned enciphered source program 20, to a program deciphering system 200.

As a result, the program deciphering system 200 deciphers only the corresponding functional part 20A. As a result, a source program 11 is obtained output from the program deciphering system 200. The source program 11 includes the functional part 20A thus deciphered, and the other functional parts 20B and 20C left undeciphered.

Next, the user compiles the thus-obtained source program 11 into an executable file. The source program 11 further includes the executable file creation control codes 25B and 25C as shown in FIG. 2, which have been embedded in the enciphered source program 20 for the purpose of preventing an error from occurring when the source program including enciphered parts is compiled into an executable file as mentioned above with reference to FIG. 1. As a result, no error occurs when the source program 11 including the enciphered functional parts 20B and 20C is thus actually compiled into an executable file. After the source program 11 is thus compiled into the executable file, the user can actually use the function A from the thus deciphered functional part 10A included in the source program 11 as shown in FIG. 2.

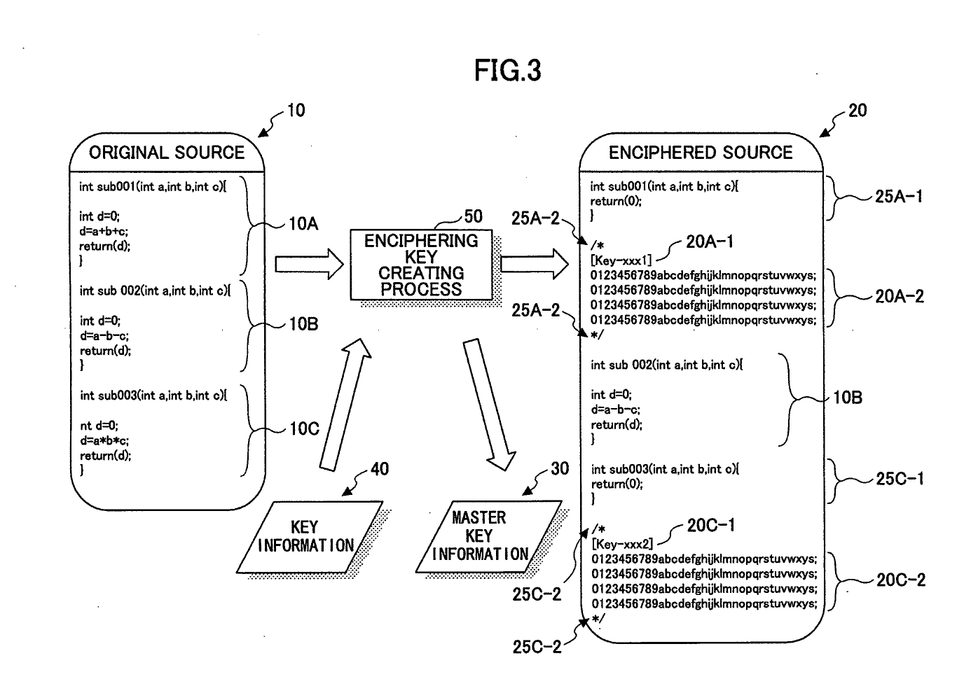

Next, an embodiment 2 will be described with reference to FIGS. 3 through 6.

FIG. 3 illustrates a process which is carried out by a program providing party to encipher a source program to be provided to a user.

A source program 10 before being enciphered includes three functional parts 10A, 10B and 10C, which provide different functions, respectively.

The above-mentioned functional parts 10A, 10B and 10C actually provide the following functions A, B and C. The function A is to have integers a, b and c input, and output an addition result d thereof, i.e., d=a+b+c, as shown in FIG. 3. The function B is to have integers a, b and c input, and output a subtraction result d thereof, i.e., d=a−b−c, as shown in FIG. 3. The function C is to have integers a, b and c input, and output a multiplication result d thereof, i.e., d=a×b×c, as shown in FIG. 3.

It is noted that, in an example which will be described first, the functional part 10A and 10C should be enciphered from among the above-mentioned functional parts A, B and C, but the functional part 10B should not be enciphered, because the user has requested the program providing party for a specific function corresponding to the functional part 10B first.

Enciphering is carried out with the use of key information 40 acting as an enciphering key. The enciphering information 40 includes such information as to encipher the functional parts 10A and 10C in different ways, respectively.

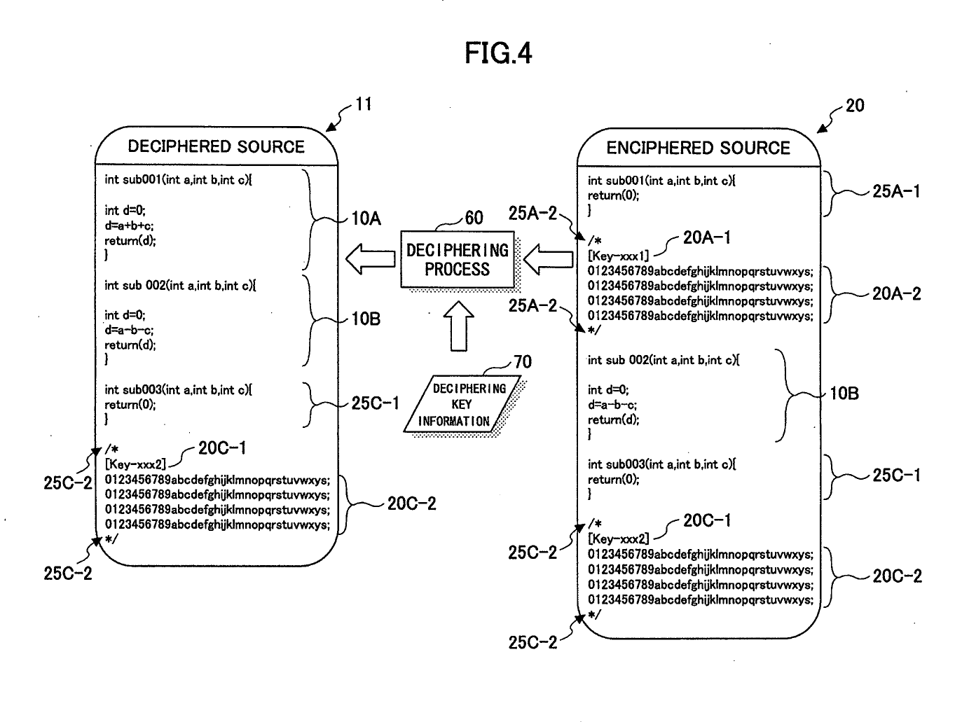

The key information used for enciphering the functional parts 10A and 10C, respectively, are identified by key identification information Key-xxx1 and Key-xxx2, respectively. A deciphering key information file 70 shown in FIG. 4 which will be described later also includes deciphering key information having different contents for the respective functional parts 10A and 10C separately. As a result, the deciphering key information (Key-xxx1) concerning the functional part 10A, included in the deciphering key information file 70, can be used only for deciphering the enciphered functional part 10A. The enciphered functional part 10C cannot be deciphered with the use of the deciphering key information concerning the functional part 10A. In the same way, the deciphering key information (Key-xxx2) concerning the functional part 10C, included in the deciphering key information file 70, can be used only for deciphering the enciphered functional part 10C. The enciphering functional part 10A cannot be deciphered with the use of the deciphering key information concerning the functional part 10C. Thus, it is possible to restrict a scope to be disclosed to the user to a minimum necessary one.

An enciphering and key generating process 50 is carried out on the source program 10 which is not yet enciphered with the use of the key information 40, as shown in FIG. 3. As a result, a source program 20 after being enciphered is obtained.

As shown in FIG. 3, the source program 20 after being enciphered includes the functional part 10B the same as the functional part 10B also included in the original source program 10. The source program 20 after being enciphered also includes enciphered functional parts 20A-2, 20C-2, obtained as a result of the functional part 10A, 10C included in the original source program 10 being enciphered with the use of the respective key information Key-xxx1 and Key-xxx2. The source program 20 after being enciphered further includes key identification information 20A-1, 20C-1 concerning the enciphered functional parts 20A-2, 20C-2 having been thus enciphered. The source program 20 after being enciphered further includes symbol parts 25A-2, 25C-2 used for causing the enciphered functional parts 20A-2, 20C-2 and the key identification information 20A-1, 20C-1 to be recognized as comments. The source program 20 after being enciphered further includes executable file creation control codes 25A-1, 25C-1 corresponding to the enciphered functional parts 20A-2, 20C-2, respectively. A process of providing the executable file creation control codes 25A-1 and 25C-1 as well as the symbol parts 25A-2 and 25C-2 to the source program 20, for example, is referred to as a predetermined executable file compile possible process.

The program providing party provides the thus-obtained enciphered source program 20, shown in FIG. 3, to the user. The user can compile the thus-received enciphered source program 20 into an executable file without errors. This is because, in the enciphered source program 20, the executable file creation control codes 25A-1, 25C-1 are included as mentioned above.

The executable file creation control codes 25A-1, 25C-1 are so-called stub functions, which have the first lines the same as the first lines of the corresponding functional parts 10A, 10C of the source program 10 before being enciphered, respectively, as shown in FIG. 3. As a result, a form of the source program 20 after being enciphered is the same as a form of the source program 10 before being enciphered.

That is, the source program 20 after being enciphered has, the executable file creation control codes 25A-1, 25C-1 as the stub functions has descriptions “mint sub001(int a,int b,int c){”, “int sub003(int a,int b,int c){”, corresponding to descriptions “int sub001(int a,int b,int c){”, “int sub003(int a,int b,int c){” which are the respective first lines of the functional parts 10A, 10C included in the sourced program 10 before being enciphered. Therewith, the source program 20 after being enciphered has the same form as that of the source program 10 before being enciphered and thus, can be compiled into an executable file without errors.

However, the functional parts 10A, 10C are enciphered into the functional parts 20A-1, 20C-1, in the source program 20. Therefore, after the source program 20 after being enciphered is thus compiled intro the executable file as mentioned above, the functions corresponding to the functional parts 10A, 10C cannot be executed. Actually, after the source program 20 after being enciphered is thus compiled into the executable file, the above-mentioned executable file creation control codes 25A-1, 25C-1 act as the stub functions in the executable file, instead of the functional parts 10A, 10C, and carry out formal operation to output “0” in response to integers a, b and c being input, by the descriptions “return(0)” included in the executable file creation control codes 25A-1, 25C-1 shown in FIG. 3.

Further, the enciphered functional parts 20A-2, 20C-2 and the corresponding key identification information 20A-1, 20C-1 are recognized merely as comments by the symbol parts 25A-2, 25C-2 which are provided for this purpose as mentioned above. As a result, the enciphered parts 20A-2, 20C-2 and the corresponding key identification information 20A-1, 20C-1 are still recognized as comments also after the enciphered source program 20 is compiled into the executable file. Thereby, it is possible to prevent errors from occurring when the enciphered source program, which includes the enciphered functional parts 20A-2, 20C-2, is compiled into the executable file. That is, when the enciphered source program is compiled into the executable file, only the functional part 10B is compiled into an executable form, and thus, only the corresponding function is made executable. The enciphered parts 20A-2, 20C-2 and the corresponding key identification information 20A-1, 20C-1 are prevented from being a target for being compiled into an executable form because the enciphered parts 20A-2, 20C-2 and the corresponding key identification information 20A-1, 20C-1 are recognized merely as comments as a result of the symbol parts 25A-2, 25C-2 being inserted before and after the same, as shown in FIG. 3.

Thus, according to the embodiment 2, before and after each of the enciphered functional parts 20A-2, 20C-2, the above-mentioned executable file creation control codes 25A-1, 25C-1 as the stub functions, as well as the symbol parts 25A-2, 25C-2 causing the enciphered functional parts 20A-2, 20C-2 to be recognized as comments are inserted, as shown in FIG. 3. As a result, the enciphered source program 20 can be compiled into the executable file without errors in the state in which the enciphered functional parts 20A-2, 20C-2 are included.

A master key information file 30 shown in FIG. 3 is a file in which, information for deciphering the above-mentioned enciphered functional parts 20A-2, 20C-2, respectively, is written. The information for deciphering the enciphered functional parts 20A-2, 20C-2 respectively, corresponds to the above-mentioned key identification information Key-xxx1, Key-xxx2, respectively.

The program providing party holds the master key information file 30 which is obtained when the source program 10 is enciphered. The program providing party may extract from the master key information file 30 key information corresponding to a specific functional part which a user requires, writes the extracted key information to a deciphering key information file 70 which will be described later, and provides the deciphering key information file 70 to the user when or after providing the enciphered source program 20 to the user. The user uses the thus-provided key information corresponding to the specific functional part which the user requires, and deciphers the corresponding functional part of the received enciphered source program 20. Thus, the user can actually use a corresponding function. The user cannot decipher the other functional parts included in the enciphered source program 20, with the use of the key information included in the provided deciphering key information file 70, and thus, the user cannot use the functions corresponding to the other functional parts.

Next, with reference to FIG. 4, a process for the user to use the enciphered source program 20 with the use of the deciphering key information file 70 will be described.

That is, in an example which will now be described, the user requires the function A corresponding to the enciphered functional part 20A-2, in addition to the function B corresponding to the functional part 10B, which is not enciphered as mentioned above, in the provided source program 20 after being enciphered shown in FIG. 4.

In this case, the user requires the program providing party for the deciphering key information file 70 for the purpose of deciphering the enciphered functional part 20A-2, to actually use the corresponding function A. The user carries out a deciphering process 60 on the provided source program 20 after being enciphered with the use of the deciphering key information file 70 thus obtained from the program providing party.

As mentioned above, in the deciphering key information file 70 thus obtained from the program providing party, the key information necessary to decipher the enciphered functional part 20A-2 is included. The key information is identified by the above-mentioned key identification information Key-xxx1. With the use of the key information, the enciphered functional part 20A-2 is deciphered, and a deciphered source program 11 shown in FIG. 4 is obtained through the deciphering process 60.

In the deciphered source program 20, as shown in FIG. 4, the executable file creation control code 25A-1, the enciphered functional part 20A-2, the key identification information 20A-1 and the symbol parts 25A-2 are replaced by the deciphered functional part 10A. That is, while the enciphered functional part 20A-2 is deciphered into the thus-deciphered functional part 10A with the use of the key identification information 20A-1 (which is also removed), the executable file creation control code 25A-1 and the symbol part 25A-2 for causing the enciphered functional parts to be recognized as comments are removed, as shown in FIG. 4. As a result, the deciphered source program 11 has the same form as that of the original source program 10. A process of removing the executable file creation control code 25A-1 and the symbol part 25A-2 from the source program, for example, is referred to as a predetermined removing process.

That is, the deciphered source program 11 has descriptions “int sub001(int a,int b,int c){”, “int sub002(int a,int b,int c){”, corresponding to descriptions “int sub001(int a,int b,int c){”, “int sub002(int a,int b,int c){” which are the respective first lines of the functional parts 10A, 10B included in the original source program 10 before being enciphered shown in FIG. 3, accompanied by substantial operation parts which provide the corresponding functions A and B. The deciphered source program 11 also has “int sub003(int a,int b,int c){”, corresponding to description “int sub003(int a,int b,int c){” which is the first line of the functional part 10C also included in the original source program 10 before being enciphered shown in FIG. 3, accompanied by a formal operation part including a description “return(0)” to output “0” in response to integers a, b and c being input. Therefore, the deciphered source program 11 has the same form as that of the source program 10 before being enciphered, and thus, can be compiled into an executable file without errors,

As shown in FIG. 4, the deciphered source program 11 has, in addition to the functional part 10B which is not enciphered originally, the functional part 10A which is thus deciphered in the deciphering process 60, both of which act as respective valid functional parts.

These valid functional parts 10A, 10B are compiled into an executable form when the deciphered source program 11 is compiled into an executable file. Thus, the functional parts 10A, 10B are executable. On the other hand, the enciphered functional part 20C-2 is not deciphered in the deciphering process 60 because key information required for deciphering the enciphered functional part 20C-2 is not included in the deciphering key information file 70. Thus, in the deciphered source program 11, the enciphered functional part 20C-2 is left undeciphered. As shown in FIG. 4, the enciphered functional part 20C-2 is caused to be recognized as comments as a result of the symbol parts 25C-2 being inserted before and after the same, as mentioned above. As a result, the same as in the enciphered source program 20 shown in FIG. 3, the enciphered functional part 20C-2 is recognized as comments when the deciphered source program 11 is compiled into an executable file. Thus, the enciphered functional part 20C-2 is prevented from being a target for being compiled into an executable form. Thus, the enciphered functional part 20C-2 is left uncompiled, as a result, the enciphered functional part 20C-2 is not executable and thus, the corresponding function C cannot be actually used.

Thus, in the embodiment 2, the program providing party prepares, for each of all users, the same source program 10. Then, the program providing party provides the source program to each user in such a state that the respective functional parts are enciphered. When a specific function which each user requires is different among the respective users, key information required for deciphering the corresponding functional part is also provided to each user. Further, as mentioned above, the above-mentioned executable file creation control codes and symbol parts for causing the enciphered functional parts to be recognized as comments are inserted for the enciphered functional parts before the source program 10 is provided to each user. As mentioned above, a process of inserting the above-mentioned executable file creation control codes and symbol parts for causing the enciphered functional parts to be recognized as comments for the enciphered functional parts, for example, corresponds to a predetermined executable file compile possible process.

The user receiving the source program 10 and the key information deciphers the necessary functional part from the source program 10 with the use of the key information. At this time, for the thus-deciphered functional part, the executable file creation control codes and the symbol parts for causing the enciphered functional parts to be recognized as comments are removed as mentioned above with reference to FIG. 4. A process of removing the executable file creation control codes and the symbol parts for causing the enciphered functional parts to be recognized as comments, for example, corresponds to a predetermined removing process. On the other hand, the thus-obtained deciphered source program includes the still enciphered functional parts (referred to as second functional parts, hereinafter) together with the thus-deciphered functional part. In the source program, the executable file creation control codes and the symbol parts for causing the enciphered functional parts to be recognized as comments are provided for the second functional parts as mentioned above. As a result, although the source program includes the second functional parts which are enciphered, no error will occur when the source program is compiled into an executable file. As a result, the user can obtain the necessary function from the thus-obtained executable file which is an object program.

Further, after that, when the same user wishes to use another function corresponding to a functional part from among the second functional parts included in the source program 10, the user requests the program providing party for corresponding key information. Then, with the use of the key information, the user can decipher the corresponding functional part further from the enciphered source program 10. At this time, also for the thus-deciphered functional part, the executable file creation control codes and symbol parts for causing the enciphered functional parts to be recognized as comments are removed. A process of removing the executable file creation control codes and the symbol parts for causing the enciphered functional parts to be recognized as comments, for example, also corresponds to a predetermined removing process. On the other hand, the thus-obtained deciphered source program may include the further still enciphered functional parts (referred to as third functional parts, hereinafter) together with the thus-deciphered functional parts. In the source program, the executable file creation control codes and the symbol parts for causing the enciphered functional parts to be recognized as comments are provided for the third functional parts if any. As a result, although the source program may include the third functional parts which are enciphered, no error will occur when the source program is compiled into an executable file. As a result, the user can obtain the necessary functions from the thus-obtained executable file which is an object program.

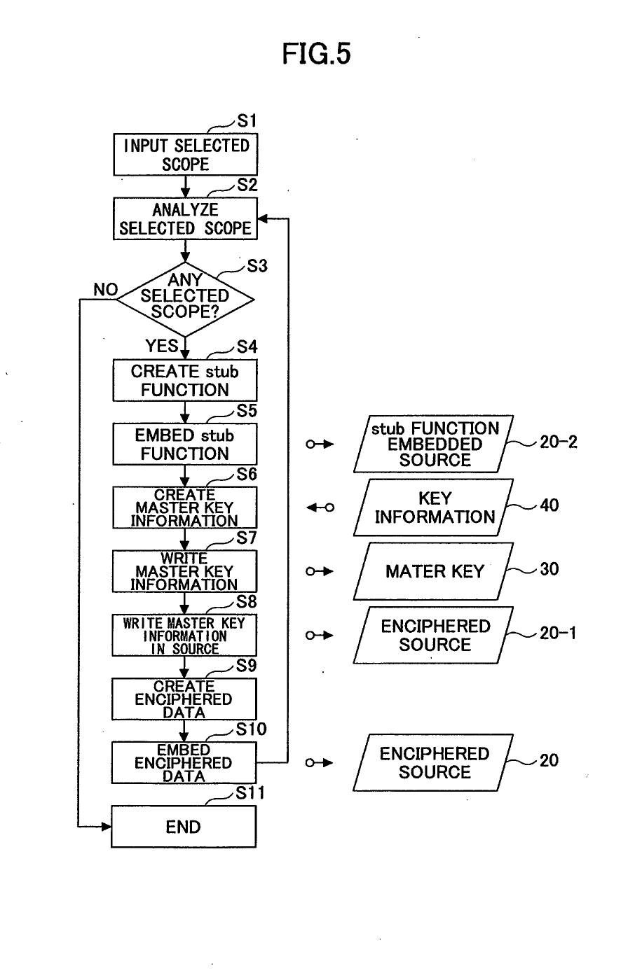

Next, with reference to FIG. 5, a process of the program providing party enciphering a source program 10, described with reference to FIG. 3, will be described.

In step S1, to the program enciphering system 100 shown in FIG. 1, a direction is input such as to select a functional part to be enciphered from functional parts included in the source program 10. The program enciphering system 100 receives the direction, and searches for the thus-selected functional part in step S2. The program enciphering system 100 then obtains the corresponding functional part to be enciphered (YES in step S3).

Then in step S4, the program enciphering system 100 creates the above-mentioned stub function or executable file creation control code (25A-1 or 25C-1 in the example of FIG. 3), and inserts it before the corresponding functional part in step S5. As a result, the source program file 20-2 in which the stub function is thus embedded is obtained. Next, key information 40 is provided to the program enciphering system 100, and the program enciphering system 100 creates master key information based on the thus-provided key information in step S6. The program enciphering system 100 writes the master key information to a master key information file 30 in step S7.

Next, in step S8, the program enciphering system 100 writes key identification information (20A-1 or 20C-1, in the example of FIG. 3) from the master key information subsequent to the stub function in the source program. Then, in step S9, the program enciphering system 100 uses the key information 40 of the master key information to encipher the corresponding functional part. The program enciphering system 100 embeds thus-obtained enciphered functional parts (20A-2 or 20C-2 in the example of FIG. 3) to the source program file in step S10. Thus, the source program file 20 is obtained.

When the above-mentioned direction input in step S1 designates a further functional part to be enciphered, steps S2 through S10 is repeated accordingly.

When it is determined in step S3 that all the functional parts to be enciphered have been enciphered, or there is no functional part to be enciphered in the source program 10, the current enciphering process is finished in step S11.

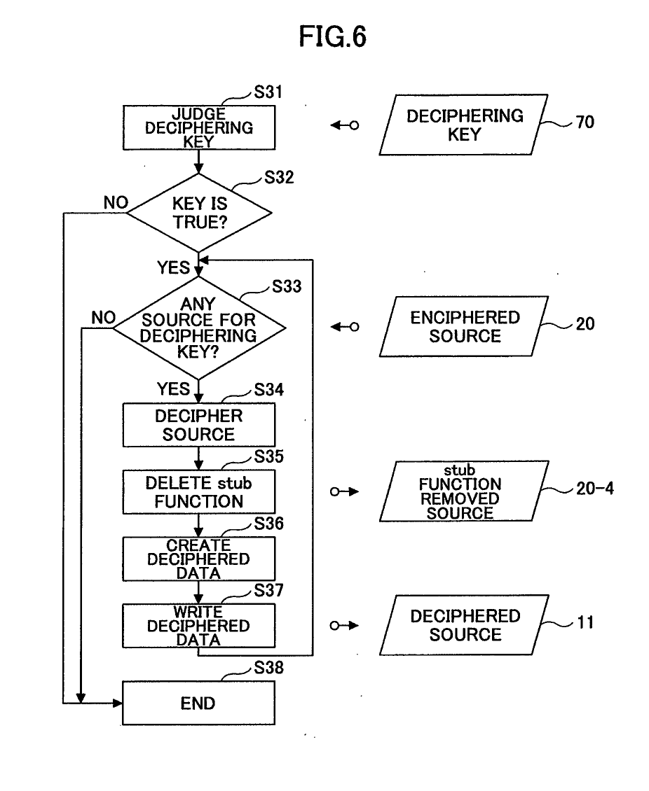

Next, with reference to FIG. 6, a process of a user who has received an enciphered source program 20 deciphering the enciphered source program described above with reference to FIG. 4, will be described.

The user inputs, to the program deciphering system 200, deciphering key information file 70 in which key information for deciphering a necessary functional part corresponding to a necessary function from the enciphered source program 20 received from a program providing party, is written.

In step S31, the program deciphering system 200 judges the deciphering key information file 70. That is, in step S32, the program deciphering system 200 checks a data format of the deciphering key information file 70, to determine whether the deciphering key information file 70 fulfills predetermined formal requirements.

When determining that the deciphering key information file 70 fulfills the predetermined formal requirements (YES in step S32), the program deciphering system 200 determines whether the functional part corresponding to the above-mentioned key information written in the deciphering key information file 70 is actually included in the enciphered source program 20 which is provided by the user, in step S33. This determination is made with the use of key identification information (Key-xxx1 20A-1 or Key-xxx2 20C-1 in the example of FIG. 4) written in the enciphered source program 20 along with the corresponding enciphered functional part (20A-2 or 20C-2 in the example), for example.

When determining in step S33 that the corresponding functional part exists in the enciphered source program 20 (YES in step S33), the program deciphering system 200 uses the key information written in the deciphering key information file 70 to decipher the corresponding functional part (20A-2 or 20C-2 in the example of FIG. 4) in step S34. As a result, the original functional part (10A or 10C in the example) is obtained.

Next, the program deciphering system 200 removes the stub function as the executable file creation control code (25A-1 or 25C-1 in the example) from the thus-deciphered functional part, and thus, obtains a source program 20-4 from which the stub function have been thus removed, in step S35. The stub function is provided for the purpose of keeping a predetermined program form in such a state that the corresponding functional part is enciphered and thus invalidated. Therefore, the stub function is useless now in a state in which the corresponding functional part has been thus deciphered and validated. At this time, by the same reason, the program deciphering system 200 removes the key identification information (20A-1 or 20C-1 in the example) and the symbol parts (25A-2 or 25C-2) for causing the enciphered functional part to be recognized as comments, which are now useless, to create a deciphered source program 11, in step S36.

The program deciphering system 200 replaces the original enciphered functional part (20A-2 or 20C-2 in the example) with the thus-deciphered functional part (10A or 10C in the example) in the source program in step S37. As a result, the source program file 11 is obtained.

The program deciphering system 200 repeats steps S33 through S38 as long as any enciphered functional part corresponding to the key information written in the deciphering key information file 70 is left in the deciphered source program 11.

On the other hand, when a determination result of step S32 or S33 is NO, the current process is finished.

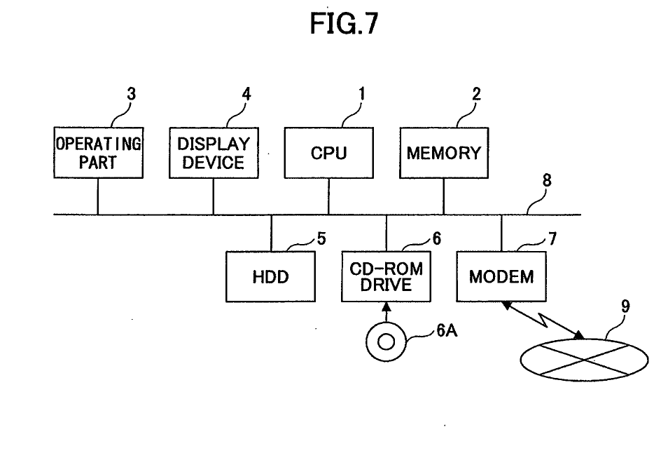

Next, with reference to FIG. 7, a computer which can be used as the program enciphering system 100 or the program deciphering system 200, described above, will be described.

A computer shown in FIG. 7 includes a CPU 1, a memory 2, a display device 4, an operating part 3, a hard disk drive 5, a CD-ROM drive 6 and a modem 7. The CPU 1 controls information processing. The memory 2 is used as a storing means by the CPU 1. The display device 4 displays information to a user. The operating part 3 is used by the user to input various directions, data and so forth. The hard disk drive 5 stores programs or various data. The CD-ROM drive 6 is used to transfer programs, data and so forth externally with the use of a CD-ROM 6A acting as a portable computer readable information recording medium. The modem 7 is used to transfer programs, data and so forth from an external server via a communication network 9 such as the Internet, a LAN or such.

When the computer is used as the program enciphering system 100 or the program deciphering system 200, a program is created including instructions for causing the computer to carry out operations of the program enciphering system 100 or the program deciphering system 200 described above with reference to FIGS. 1 through 6.

Next, the thus-created program is written in the CD-ROM 6A, is then transfer to the hard disk drive 5 via the CD-ROM drive 6 under the control of the CPU 1, and thus, is loaded in the computer.

Alternatively, the thus-created program is transfer to the hard disk drive 5 via the communication network 9 under the control of the CPU 1, and thus, is loaded in the computer.

After that, the CPU 1 responds to a direction input by means of the operating part 3 from a user, loads the above-mentioned program in the memory 2 from the hard disk drive 5, and executes the instructions from the program in sequence. As a result, the computer functions as the program enciphering system 100 or the program deciphering system 200.

The present invention is not limited to the specifically disclosed embodiments, and variations and modifications may be made without departing from the scope of the present invention.

What is claimed is:

1. A program processing apparatus comprising at least any one of:
an executable file compile possible part configured to carry out a predetermined executable file compile possible process to a program to make it possible to compile into an executable file in such a state that the program has at least a part thereof enciphered; and
a removal processing part configured to carry out a predetermined removing process to a program to remove an influence of the predetermined executable file compile possible process, which program has at least a part thereof enciphered and further has undergone the predetermined executable file compile possible process.

2. The program processing apparatus as claimed in claim 1, wherein:
said predetermined executable file compile possible process comprises a process of preventing an error from occurring when the program is compiled into an executable file in such a state that the program has at least a part thereof enciphered.

3. The program processing apparatus as claimed in claim 1, wherein:
said predetermined executable file compile possible process comprises at least one of a process of inserting a code having a function of carrying out formal operation and a process of inserting a symbol part causing the at least a part enciphered to be recognized as comments.

4. The program processing apparatus as claimed in claim 1, wherein:
said predetermined removing process comprises at least one of a process of removing a code having a function of carrying out formal operation and a process of inserting such a symbol part causing the at least a part enciphered to be recognized as comments, which code or symbol part has been inserted in said predetermined executable file compile possible process.

5. The program processing apparatus as claimed in claim 1, wherein:
said program at least a part of which is enciphered comprises a source program.

6. A program processing method comprising at least any one of:
a) carrying out a predetermined executable file compile possible process to a program to make it possible to compile into an executable file in such a state that the program has at least a part thereof enciphered; and
b) carrying out a predetermined removing process to a program to remove an influence of the predetermined executable file compile possible process, which program has at least a part thereof enciphered and further has undergone the predetermined executable file compile possible process.

7. The program processing method as claimed in claim 6, wherein:
said predetermined executable file compile possible process comprises a process of preventing an error from occurring when the program is compiled into an executable file in such a state that the program has at least a part thereof enciphered.

8. The program processing method as claimed in claim 6, wherein:
said predetermined executable file compile possible process comprises at least one of a process of inserting a code having a function of carrying out formal operation and a process of inserting a symbol part causing the at least a part of the program enciphered to be recognized as comments.

9. The program processing method as claimed in claim 6, wherein:
said predetermined removing process comprises at least one of a process of removing a code having a function of carrying out formal operation and a process of inserting a symbol part causing the at least a part of the program enciphered to be recognized as comments, which code or symbol part has been inserted in said predetermined executable file compile possible process.

10. The program processing method as claimed in claim 6, wherein:
said program at least a part of which is enciphered comprises a source program.

11. A program processing method comprising:
a) enciphering other functional parts than desired functional parts of a program which includes a plurality of functional parts; and
b) carrying out an executable file compile possible process to the program, in which the other functional parts than the desired function parts are enciphered.

12. The program processing method as claimed in claim 11, further comprising:
c) deciphering at least a functional part included in the other functional parts of the program, in which the other functional parts than the desired functional parts are enciphered.

13. A computer readable information recording medium storing a program which, when executed by one or more processors, carries out at least one of:
a) carrying out a predetermined executable file compile possible process to a program to make it possible to compile into an executable file, in such a state that the program has at least a part thereof enciphered; and
b) carrying out a predetermined removing process to a program to remove an influence of the predetermined executable file compile possible process, which program has at least a part thereof enciphered and further has undergone the predetermined executable file compile possible process.

14. The computer readable information recording medium as claimed in claim 13, wherein:
said predetermined executable file compile possible process comprises a process of preventing an error from occurring when the program is compiled into an executable file in such a state that the program has at least a part thereof enciphered.

15. The computer readable information recording medium as claimed in claim 13, wherein:
said predetermined executable file compile possible process comprises at least one of a process of inserting a code having a function of carrying out formal operation and a process of inserting a symbol part causing the at least a part of the program enciphered to be recognized as comments.

16. The computer readable information recording medium as claimed in claim 13, wherein:
said predetermined removing process comprises at least one of a process of removing a code having a function of carrying out formal operation and a process of inserting a symbol part causing the at least a part of the program enciphered to be recognized as comments, which code or symbol part has been inserted in said predetermined executable file compile possible process.

17. The computer readable information recording medium as claimed in claim 13, wherein:
said program at least a part of which is enciphered comprises a source program.
